(19) United States
(12) Patent Application Publication
(10) Pub. No.: US 2024/0302839 A1
(43) Pub. Date: Sep. 12, 2024

(54) MAPPING NEGATIVE SPACE FOR AUTONOMOUS MOBILE ROBOT

(71) Applicant: iRobot Corporation, Bedford, MA (US)

(72) Inventor: Jyh-Ming Lien, Arcadia, CA (US)

(21) Appl. No.: 18/118,825

(22) Filed: Mar. 8, 2023

(51) Int. Cl. G05D 1/02; A47L 9/28; G01C 21/00; G05B 19/4155

(52) U.S. Cl. CPC G05D 1/0251; A47L 9/2805; G01C 21/383; G01C 21/3833; G01C 21/3867; G05B 19/4155; A47L 2201/00; G05B 2219/50391

(57) ABSTRACT

A non-transitory machine-readable medium, including instructions, which when executed, cause processing circuitry to perform operations to receive sensor data from a mobile cleaning robot based on interactions between the mobile cleaning robot and an environment. The instructions can further cause the processing circuitry to perform operations to generate a boundary of traversable space by the mobile cleaning robot within the environment using the sensor data, the boundary at least partially defining non-traversable space of the environment, and the non-traversable space including a region beyond the boundary. The instructions can further cause the processing circuitry to perform operations to generate a modified boundary of the environment using the non-traversable space and the sensor data.

### BACKGROUND

Autonomous mobile cleaning robots can traverse floor surfaces to perform various operations in an environment, such as vacuuming of one or more rooms of the environment. A cleaning robot can include a controller configured to autonomously navigate the robot about an environment such that the robot can ingest debris as it moves. As an autonomous mobile robot traverses a floor surface, the robot can produce and record information about the environment and the robot, such as to generate a map of the environment for use in cleaning operations.

### SUMMARY

Mobile cleaning robots can be used by users, such as homeowners, to perform ad hoc or scheduled cleaning missions. During missions, robots can autonomously navigate the environment and perform cleaning operations, such as vacuuming or mopping (or both). During navigation and cleaning, a robot can use its camera to detect objects within the environment, such as for odometry, avoidance, or scene understanding. This detection can help the robot to perform better cleaning operations, make and use a map of the environment, and avoid ingestion of non-debris items. Other sensors of the robot, including wheel encoders, optical sensors, or positioning sensors can also be used to develop and update the map. However, when items and rooms are mapped, relatively large items, such as a bed with non-traversable space below, can appear as a wall, affecting a shape of the displayed room. In such cases, a visual display of the map can be unrecognizable to (or difficult to recognize for) the user.

This disclosure describes examples of devices, systems, and methods that can help to address this problem such as by using additional data collected by the robot to modify a boundary of the environment. The modified boundary can be presented to the user in a modified map in a format that more accurately represents the environment, helping a user to more easily recognize the environment, allowing for quicker and easier set up of the environment, such as naming of rooms and spaces. The more accurate map can be used by the robot to more effectively or efficiently clean a space. Additionally, the data can be used to develop a three dimensional map of the environment to produce an even more realistic representation of the environment.

Also, some current mapping techniques emphasize the boundary of traversal space which can change from mission to mission and time to time. By using negative spaces, a boundary can be determined and applied to a map, which is more likely to represent an actual boundary of the environment (e.g., a wall) and is therefore less likely to move. This can help reduce confusion from users encountering changes in the map.

For example, a non-transitory machine-readable medium, including instructions, which when executed, cause processing circuitry to perform operations to receive sensor data from a mobile cleaning robot based on interactions between the mobile cleaning robot and an environment. The instructions can further cause the processing circuitry to perform operations to generate a boundary of traversable space by the mobile cleaning robot within the environment using the sensor data, the boundary at least partially defining non-traversable space of the environment, and the non-traversable space including a region beyond the boundary. The instructions can further cause the processing circuitry to perform operations to generate a modified boundary of the environment using the non-traversable space and the sensor data.

The above discussion is intended to provide an overview of subject matter of the present patent application. It is not intended to provide an exclusive or exhaustive explanation of the invention. The description below is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a plan view of a mobile cleaning robot in an environment.

FIG. 2A illustrates a bottom view of a mobile cleaning robot.

FIG. 2B illustrates an isometric view of a mobile cleaning robot.

FIG. 3 illustrates a cross-section view across indicators 3-3 of FIG. 2A of a mobile cleaning robot.

FIG. 4A illustrates a diagram illustrating an example of a communication network in which a mobile cleaning robot operates and data transmission in the network.

FIG. 4B illustrates a schematic view of a network.

FIG. 5 illustrates a schematic view of a process of developing or refining a map of an environment.

FIG. 6 illustrates a plan view of a map of an environment.

FIG. 7 illustrates a plan view of a map of an environment.

FIG. 8 illustrates a plan view of a map of an environment.

FIG. 9 illustrates a plan view of a map of an environment.

FIG. 10 illustrates a plan view of a map of an environment.

FIG. 11 illustrates a plan view of a map of an environment.

FIG. 12 illustrates a plan view of a map of an environment.

FIG. 13 illustrates a plan view of a map of an environment.

FIG. 14 illustrates a perspective view of a map of an environment.

FIG. 15 illustrates a plan view of a map of an environment.

FIG. 16 illustrates a plan view of a map of an environment.

FIG. 17A illustrates a plan view of a map of an environment.

FIG. 17B illustrates a plan view of a map of an environment.

FIG. 18 illustrates a block diagram illustrating an example of a machine upon which one or more embodiments may be implemented.

### DETAILED DESCRIPTION

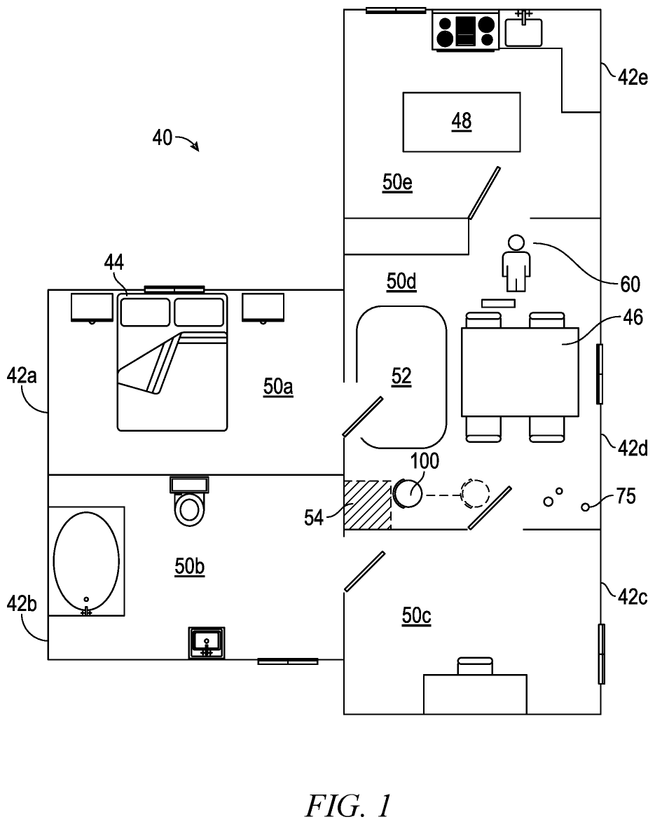

FIG. 1 illustrates a plan view of a mobile cleaning robot 100 in an environment 40, in accordance with at least one example of this disclosure. The environment 40 can be a dwelling, such as a home or an apartment, and can include rooms 42a-42e. Obstacles, such as a bed 44, a table 46, and an island 48 can be located in one or more of the rooms 42 of the environment. Each of the rooms 42a-42e can have a floor surface 50a-50e, respectively. Some rooms, such as the room 42d, can include a rug, such as a rug 52. The floor surfaces 50 can be of one or more types of flooring, such as hardwood, ceramic, low-pile carpet, medium-pile carpet, long (or high)-pile carpet, stone, or the like.

The mobile cleaning robot 100 can be operated, such as by a user 60, to autonomously clean the environment 40 in a room-by-room fashion. In some examples, the robot 100 can clean the floor surface 50a of one room, such as the room 42a, before moving to the next room, such as the room 42d, to clean the surface of the room 42d. Different rooms can have different types of floor surfaces. For example, the room 42e (which can be a kitchen) can have a hard floor surface, such as wood or ceramic tile, and the room 42a (which can be a bedroom) can have a carpet surface, such as a medium pile carpet. Other rooms, such as the room 42d (which can be a dining room) can include multiple surfaces where the rug 52 is located within the room 42d.

During cleaning or traveling operations, the robot 100 can use data collected from various sensors and calculations (such as odometry and obstacle detection) to develop a map of the environment 40. Once the map is created, the user 60 can define rooms or zones (such as the rooms 42) within the map. The map can be presentable to the user 60 on a user interface, such as a mobile device, where the user 60 can direct or change cleaning preferences.

During operation, the robot 100 can detect surface types within each of the rooms 42, which can be stored in the robot or another device. The robot 100 can update the map (or data related thereto) such as to include or account for surface types of the floor surfaces 50a-50e of each of the respective rooms 42 of the environment. In some examples, the map can be updated to show the different surface types such as within each of the rooms 42.

In some examples, the user 60 can define a behavior control zone 54 using, for example, the methods and systems described herein. In response to the user 60 defining the behavior control zone 54, the robot 100 can move toward the behavior control zone 54 to confirm the selection. After confirmation, autonomous operation of the robot 100 can be initiated. In autonomous operation, the robot 100 can initiate a behavior in response to being in or near the behavior control zone 54. For example, the user 60 can define an area of the environment 40 that is prone to becoming dirty to be the behavior control zone 54. In response, the robot 100 can initiate a focused cleaning behavior in which the robot 100 performs a focused cleaning of a portion of the floor surface 50d in the behavior control zone 54.

### Components of the Robot

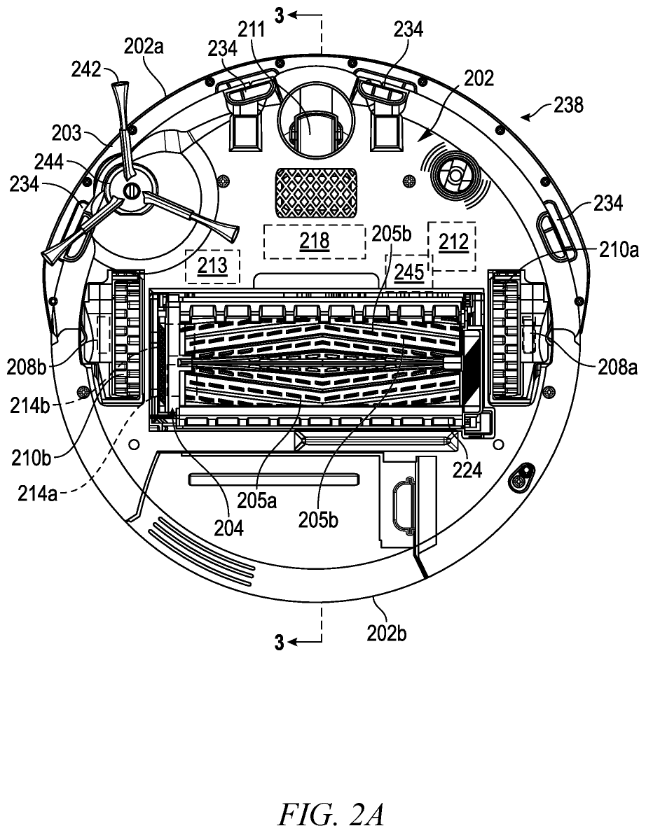

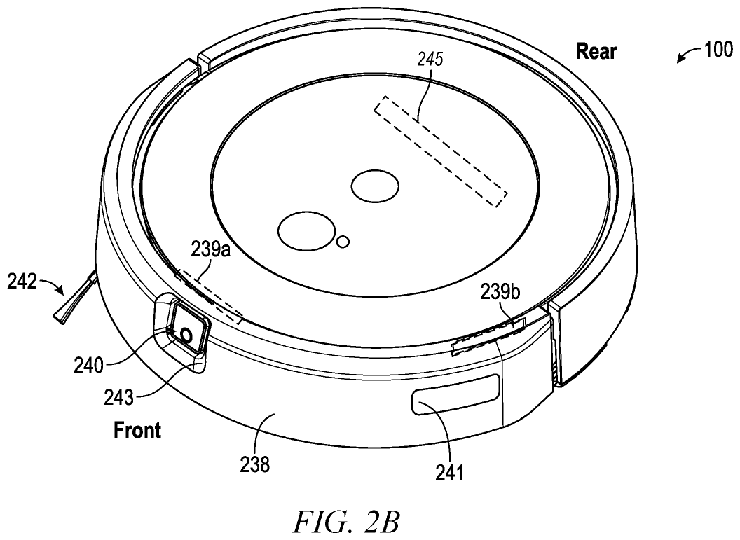

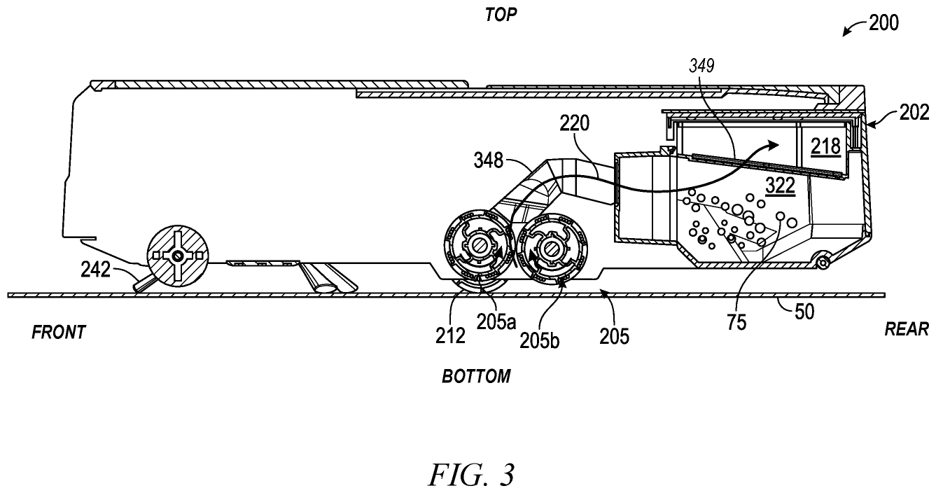

FIG. 2A illustrates a bottom view of the mobile cleaning robot 100. FIG. 2B illustrates a bottom view of the mobile cleaning robot 100. FIG. 3 illustrates a cross-section view across indicators 3-3 of FIG. 2A of the mobile cleaning robot 100. FIG. 3 also shows orientation indicators Front and Rear. FIGS. 2A-3 are discussed together below.

The cleaning robot 100 can be an autonomous cleaning robot that can autonomously traverse the floor surface 50 while ingesting the debris 75 from different parts of the floor surface 50. As shown in FIGS. 2A and 3, the robot 100 can include a body 202 movable across the floor surface 50. The body 202 can include multiple connected structures to which components of the cleaning robot 100 are mounted. The connected structures can include, for example, an outer housing to cover internal components of the cleaning robot 100, a chassis or frame to which the drive wheels 210a and 210b and the cleaning rollers 205a and 205b (of a cleaning assembly 204) are mounted, and a bumper 238. The bumper 238 can be removably secured to the body 202 and can be movable relative to the body 202 while mounted thereto. In some examples, the bumper 238 can form part of the body 202.

As shown in FIG. 2A, the body 202 includes a front portion 202a that has a substantially semicircular shape and a rear portion 202b that has a substantially semicircular shape. These portions can have other shapes in other examples, such as a square front (or rounded square front). As shown in FIG. 2A, the robot 100 can include a drive system including actuators 208a and 208b, which can be, for example, motors. The actuators 208a and 208b can be mounted in the body 202 and can be operably connected to the drive wheels 210a and 210b, which can be rotatably mounted to the body 202 to support the body 202 above the floor surface 50. The actuators 208a and 208b, when driven, can rotate the drive wheels 210a and 210b to enable the robot 100 to autonomously move across the floor surface 50.

The controller (or processor) 212 can be located within the housing and can be a programmable controller, such as a single or multi-board computer, a direct digital controller (DDC), a programmable logic controller (PLC), or the like. In other examples the controller 212 can be any computing device, such as a handheld computer, for example, a smart phone, a tablet, a laptop, a desktop computer, or any other computing device including a processor, memory, and communication capabilities. The memory 213 can be one or more types of memory, such as volatile or non-volatile memory, read-only memory (ROM), random-access memory (RAM), magnetic disk storage media, optical storage media, flash-memory devices, and other storage devices and media. The memory 213 can be located within the body 202, connected to the controller 212 and accessible by the controller 212.

The controller 212 can operate the actuators 208a and 208b to autonomously navigate the robot 100 about the floor surface 50 during a cleaning operation. The actuators 208a and 208b can be operable to drive the robot 100 in a forward drive direction, in a backwards direction, or to turn the robot 100. The robot 100 can include a caster wheel 211 that can support the body 202 above the floor surface 50. The caster wheel 211 can support the front portion 202a of the body 202 above the floor surface 50, and the drive wheels 210a and 210b can support the rear portion 202b of the body 202 above the floor surface 50.

As shown in FIG. 3, a vacuum assembly 218 can be located at least partially within the body 202 of the robot 100, e.g., in the rear portion 202b of the body 202. The controller 212 can operate the vacuum assembly 218 to generate an airflow that flows through the air gap near the cleaning rollers 205, through the body 202, and out of the body 202. The vacuum assembly 218 can include, for example, an impeller that generates the airflow when rotated. The airflow and the cleaning rollers 205, when rotated, can cooperate to ingest debris 75 into a suction duct 348 of the robot 100. The suction duct 348 can extend down to or near a bottom portion of the body 202 and can be at least partially defined by the cleaning assembly 204.

The suction duct 348 can be connected to the cleaning head 204 or cleaning assembly and can be connected to a cleaning bin 322. The cleaning bin 322 can be mounted in the body 202 and can contain the debris 75 ingested by the robot 100. A filter 349 can be located in the body 202, which can help to separate the debris 75 from the airflow before the airflow 220 enters the vacuum assembly 218 and is exhausted out of the body 202. In this regard, the debris 75 can be captured in both the cleaning bin 322 and the filter before the airflow 220 is exhausted from the body 202.

The cleaning rollers 205a and 205b can operably connected to one or more actuators 214a and 214b, e.g., motors, respectively. The cleaning head 204 and the cleaning rollers 205a and 205b can be positioned forward of the cleaning bin 322. The cleaning rollers 205a and 205b can be mounted to a housing 224 of the cleaning head 204 and mounted, e.g., indirectly or directly, to the body 202 of the robot 100. In particular, the cleaning rollers 205a and 205b can be mounted to an underside of the body 202 so that the cleaning rollers 205a and 205b engage debris 75 on the floor surface 50 during the cleaning operation when the underside faces the floor surface 50.

The housing 224 of the cleaning head 204 can be mounted to the body 202 of the robot 100. In this regard, the cleaning rollers 205a and 205b can also be mounted to the body 202 of the robot 100, such as indirectly mounted to the body 202 through the housing 224. Alternatively, or additionally, the cleaning head 204 can be a removable assembly of the robot 100 where the housing 224 (with the cleaning rollers 205a and 205b mounted therein) is removably mounted to the body 202 of the robot 100.

A side brush 242 can be connected to an underside of the robot 100 and can be connected to a motor 244 operable to rotate the side brush 242 with respect to the body 202 of the robot 100. The side brush 242 can be configured to engage debris to move the debris toward the cleaning assembly 205 or away from edges of the environment 40. The motor 244 configured to drive the side brush 242 can be in communication with the controller 212. The brush 242 can be a side brush laterally offset from a center of the robot 100 such that the brush 242 can extend beyond an outer perimeter of the body 202 of the robot 100. Similarly, the brush 242 can also be forwardly offset of a center of the robot 100 such that the brush 242 also extends beyond the bumper 238 or an outer periphery of the body 202.

The robot 100 can further include a sensor system with one or more electrical sensors. The sensor system can generate one or more signals indicative of a current location of the robot 100, and can generate one or more signals indicative of locations of the robot 100 as the robot 100 travels along the floor surface 50.

For example, cliff sensors 234 (shown in FIG. 2A) can be located along a bottom portion of the body 202. The cliff sensors 234 can include an optical sensor that can be configured to detect a presence or absence of an object below the optical sensor, such as the floor surface 50. The cliff sensors 234 can be connected to the controller 212.

The bump sensors 239a and 239b (the bump sensors 239) can be connected to the body 202 and can be engageable or configured to interact with the bumper 238. The bump sensors 239 can include break beam sensors, Hall Effect sensors, capacitive sensors, switches, or other sensors that can detect contact between the robot 100 (e.g., the bumper 238) and objects in the environment 40. The bump sensors 239 can be in communication with the controller 212.

An image capture device 240 can be connected to the body 202 and can extend at least partially through the bumper 238 of the robot 100, such as through an opening 243 of the bumper 238. The image capture device 240 can be a camera, such as a front-facing camera, configured to generate a signal based on imagery of the environment 40 of the robot 100. The image capture device 240 can transmit the image capture signal to the controller 212 for use for navigation and cleaning routines.

Obstacle follow sensors 241 (shown in FIG. 2B) can include an optical sensor facing outward or downward from the bumper 238 that can be configured to detect the presence or the absence of an object adjacent to a side of the body 202. The obstacle follow sensor 241 can emit an optical beam horizontally in a direction perpendicular (or nearly perpendicular) to the forward drive direction of the robot 100. The optical emitter can emit an optical beam outward from the robot 100, e.g., outward in a horizontal direction, and the optical detector detects a reflection of the optical beam that reflects off an object near the robot 100. The robot 100, e.g., using the controller 212, can determine a time of flight of the optical beam and thereby determine a distance between the optical detector and the object, and hence a distance between the robot 100 and the object.

The robot 100 can also optionally include one or more dirt sensors 245 connected to the body 202 and in communication with the controller 212. The dirt sensors 245 can be a microphone, piezoelectric sensor, optical sensor, or the like, and can be located in or near a flow path of debris, such as near an opening of the cleaning rollers 205 or in one or more ducts within the body 202. This can allow the dirt sensor(s) 245 to detect how much dirt is being ingested by the vacuum assembly 218 (e.g., via the extractor 204) at any time during a cleaning mission. Because the robot 100 can be aware of its location, the robot 100 can keep a log or record of which areas or rooms of the map are dirtier or where more dirt is collected. The robot 100 can also include a battery 245 operable to power one or more components (such as the motors) of the robot.

### Operation of the Robot

In operation of some examples, the robot 100 can be propelled in a forward drive direction or a rearward drive direction. The robot 100 can also be propelled such that the robot 100 turns in place or turns while moving in the forward drive direction or the rearward drive direction.

When the controller 212 causes the robot 100 to perform a mission, the controller 212 can operate the motors 208 to drive the drive wheels 210 and propel the robot 100 along the floor surface 50. In addition, the controller 212 can operate the motors 214 to cause the rollers 205a and 205b to rotate, can operate the motor 244 to cause the brush 242 to rotate, or can operate the motor of the vacuum system 218 to generate airflow. The controller 212 can also execute software stored on the memory 213 to cause the robot 100 to perform various navigational and cleaning behaviors by operating the various motors or components of the robot 100.

The various sensors of the robot 100 can be used to help the robot navigate and clean within the environment 40. For example, the cliff sensors 234 can detect obstacles such as drop-offs and cliffs below portions of the robot 100 where the cliff sensors 234 are located. The cliff sensors 234 can transmit signals to the controller 212 so that the controller 212 can redirect the robot 100 based on signals from the cliff sensors 234.

In some examples, the bump sensor 239a can be used to detect movement of the bumper 238 in one or more directions of the robot 100. For example, the bump sensor 239a can be used to detect movement of the bumper 238 from front to rear or the bump sensors 239b can detect movement along one or more sides of the robot 100. The bump sensors 239 can transmit signals to the controller 212 so that the controller 212 can redirect the robot 100 based on signals from the bump sensors 239.

In some examples, the obstacle follow sensors 241 can detect detectable objects, including obstacles such as furniture, walls, persons, and other objects in the environment of the robot 100. In some implementations, the sensors 241 can be located along a side surface of the body 202, and the obstacle following sensor 241 can detect the presence or the absence an object adjacent to the side surface. The one or more obstacle following sensors 241 can also serve as obstacle detection sensors, similar to proximity sensors. The controller 212 can use the signals from the obstacle follow sensors 241 to follow along obstacles such as walls or cabinets.

The robot 100 can also include sensors for tracking a distance travelled by the robot 100. For example, the sensor system can include encoders associated with the motors 208 for the drive wheels 210, and the encoders can track a distance that the robot 100 has travelled. In some implementations, the sensor can include an optical sensor facing downward toward a floor surface. The optical sensor can be positioned to direct light through a bottom surface of the robot 100 toward the floor surface 50. The optical sensor can detect reflections of the light and can detect a distance travelled by the robot 100 based on changes in floor features as the robot 100 travels along the floor surface 50.

The image capture device 240 can be configured to generate a signal based on imagery of the environment 40 of the robot 100 as the robot 100 moves about the floor surface 50. The image capture device 240 can transmit such a signal to the controller 212. The image capture device 240 can capture images of wall surfaces of the environment so that features corresponding to objects on the wall surfaces can be used for localization.

The controller 212 can use data collected by the sensors of the sensor system to control navigational behaviors of the robot 100 during the mission. For example, the controller 212 can use the sensor data collected by obstacle detection sensors of the robot 100 (e.g., the cliff sensors 234, the bump sensors 239, and the image capture device 240) to help the robot 100 avoid obstacles when moving within the environment of the robot 100 during a mission.

The sensor data can also be used by the controller 212 for simultaneous localization and mapping (SLAM) techniques in which the controller 212 extracts or interprets features of the environment represented by the sensor data and constructs a map of the floor surface 50 of the environment. The sensor data collected by the image capture device 240 can be used for techniques such as vision-based SLAM (VSLAM) in which the controller 212 can extract visual features corresponding to objects in the environment 40 and can construct the map using these visual features. As the controller 212 directs the robot 100 about the floor surface 50 during the mission, the controller 212 can use SLAM techniques to determine a location of the robot 100 within the map by detecting features represented in collected sensor data and comparing the features to previously stored features. The map formed from the sensor data can indicate locations of traversable and non-traversable space within the environment. For example, locations of obstacles can be indicated on the map as non-traversable space, and locations of open floor space can be indicated on the map as traversable space.

The sensor data collected by any of the sensors can be stored in the memory 213. In addition, other data generated for the SLAM techniques, including mapping data forming the map, can be stored in the memory 213. These data produced during the mission can include persistent data that are produced during the mission and that are usable during further missions. In addition to storing the software for causing the robot 100 to perform its behaviors, the memory 213 can store data resulting from processing of the sensor data for access by the controller 212. For example, the map can be a map that is usable and updateable by the controller 212 of the robot 100 from one mission to another mission to navigate the robot 100 about the floor surface 50.

The persistent data, including the persistent map, helps to enable the robot 100 to efficiently clean the floor surface 50. For example, the map enables the controller 212 to direct the robot 100 toward open floor space and to avoid non-traversable space. In addition, for subsequent missions, the controller 212 can use the map to optimize paths taken during the missions to help plan navigation of the robot 100 through the environment 40.

### Mapping Examples

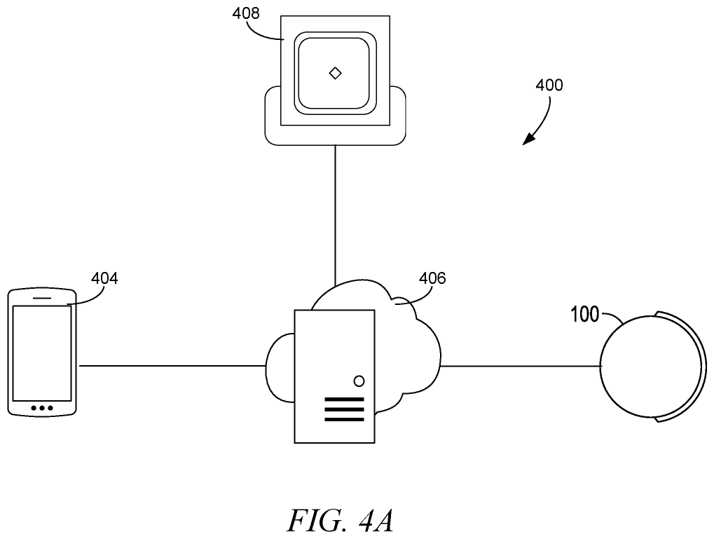

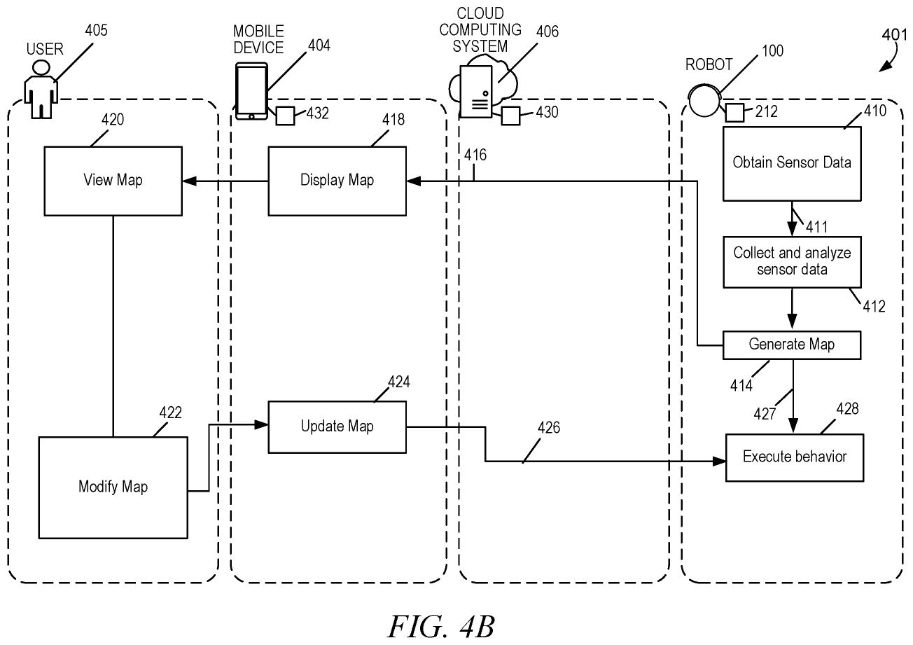

FIG. 4A is a diagram illustrating an example of a communication network 400 that can enable networking between the mobile robot 100 and one or more other devices, such as a mobile device 404, a cloud computing system 406, or another autonomous robot 408 separate from the mobile robot 404. Using the communication network 410, the robot 100, the mobile device 404, the robot 408, and the cloud computing system 406 can communicate with one another to transmit and receive data from one another. In some examples, the robot 100, the robot 408, or both the robot 100 and the robot 408 communicate with the mobile device 404 through the cloud computing system 406. Alternatively, or additionally, the robot 100, the robot 408, or both the robot 100 and the robot 408 communicate directly with the mobile device 404. Various types and combinations of wireless networks (e.g., Bluetooth, radio frequency, optical based, etc.) and network architectures (e.g., mesh networks) can be employed by the communication network 410.

In some examples, the mobile device 404 can be a remote device that can be linked to the cloud computing system 406 and can enable a user to provide inputs. The mobile device 404 can include user input elements such as, for example, one or more of a touchscreen display, buttons, a microphone, a mouse, a keyboard, or other devices that respond to inputs provided by the user. The mobile device 404 can also include immersive media (e.g., virtual reality) with which the user can interact to provide input. The mobile device 404, in these examples, can be a virtual reality headset or a head-mounted display.

The user can provide inputs corresponding to commands for the mobile robot 404. In such cases, the mobile device 404 can transmit a signal to the cloud computing system 406 to cause the cloud computing system 406 to transmit a command signal to the mobile robot 100. In some implementations, the mobile device 404 can present augmented reality images. In some implementations, the mobile device 404 can be a smart phone, a laptop computer, a tablet computing device, or other mobile device.

According to some examples discussed herein, the mobile device 404 can include a user interface configured to display a map of the robot environment. A robot path, such as that identified by a coverage planner, can also be displayed on the map. The interface can receive a user instruction to modify the environment map, such as by adding, removing, or otherwise modifying a keep-out zone in the environment; adding, removing, or otherwise modifying a focused cleaning zone in the environment (such as an area that requires repeated cleaning); restricting a robot traversal direction or traversal pattern in a portion of the environment; or adding or changing a cleaning rank, among others.

In some examples, the communication network 410 can include additional nodes. For example, nodes of the communication network 410 can include additional robots. Also, nodes of the communication network 410 can include network-connected devices that can generate information about the environment 40. Such a network-connected device can include one or more sensors, such as an acoustic sensor, an image capture system, or other sensor generating signals, to detect characteristics of the environment 40 from which features can be extracted. Network-connected devices can also include home cameras, smart sensors, or the like.

In the communication network 410, the wireless links can utilize various communication schemes, protocols, etc., such as, for example, Bluetooth classes, Wi-Fi, Bluetooth-low-energy, also known as BLE, 802.15.4, Worldwide Interoperability for Microwave Access (WiMAX), an infrared channel, satellite band, or the like. In some examples, wireless links can include any cellular network standards used to communicate among mobile devices, including, but not limited to, standards that qualify as 1G, 2G, 3G, 4G, 5G, or the like. The network standards, if utilized, qualify as, for example, one or more generations of mobile telecommunication standards by fulfilling a specification or standards such as the specifications maintained by International Telecommunication Union. For example, the 4G standards can correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards can use various channel access methods, e.g., FDMA, TDMA, CDMA, or SDMA.

FIG. 4B is a diagram illustrating an exemplary process 401 of exchanging information among devices in the communication network 410, including the mobile robot 100, the cloud computing system 406, and the mobile device 404.

In operation of some examples, a cleaning mission can be initiated by pressing a button on the mobile robot 100 (or the mobile device 404) or can be scheduled for a future time or day. The user can select a set of rooms to be cleaned during the cleaning mission or can instruct the robot to clean all rooms. The user can also select a set of cleaning parameters to be used in each room during the cleaning mission.

During a cleaning mission, the mobile robot 100 can perform various processes for navigation that can include data collection, such as obstacle detection and avoidance (ODOA) and visual scene understanding (VSU) 410 as it traverses an environment. The robot 100 can also perform visual simultaneous localization and mapping (VSLAM). VSLAM can be performed by the robot 100 by using an optical stream produced by the image capture device 240 and can be used by the robot 100 to compare features that are detected from frame to frame in order to build or update a map of its environment (such as the environment 40) and to localize the robot 100 within the environment. ODOA can be performed using the optical stream and can be used to detect obstacles that lie in the path of the robot, so ODOA analysis can view objects below the horizon and as close to the front of the robot as possible. VSU can be performed by analyzing the optical stream using all or most of the frame for understanding or interpreting objects within an environment, which can also be used for mapping or localization. The robot 100 can also collect data from other sensors, such as the bump sensors 239, obstacle follow sensors, 241, or any other sensor of the robot 100.

Data from one or more of the processes (or operations of the robot 100) can be saved by the robot 100, the cloud computing system 406, or the mobile device 404. These data, components, or processes can be used together to perform one or more cleaning missions, where the missions can be modifiable by the user, and can be used in other processes performed by the mobile device 404 (or a processor 432 thereof) or the cloud computing system 406. For example, at 410, the robot 100 can use one or more optical processes to determine whether an object is located within the environment. For example, the robot can use VSU to determine that an object is present within the environment and can use one or more of VO, ODOA, or VSLAM to determine the location of the object within the environment and on the map. The robot 100 can use the determined location of the object to place the object within the environment. The robot 100 can also reference a geographic location of the robot 100. The robot 100 can use the geographic location of the robot 100 to more accurately place the detected object or can store the location data of the robot for further analysis of the detected object.

The mobile robot 100 can transfer and store 411 data (e.g., one or more of location data, operational event data, time data, etc.), the detection of the object, and the location of the object within the robot 100. The robot 100 can collect, store, or analyze the sensor data 412 (or analysis performed by the robot 100), as discussed in further detail below. The robot 100 can use the information (optionally with other information) to generate or update a map of the environment 414, such as using the processor 212, which can include various steps, as discussed in further detail below. Optionally, the cloud computing system 406 can perform one or more of the steps 412 and 414.

The map can be transmitted 416 to the mobile device 404 and the mobile device 404 can display the map 418, such as on a screen of the mobile device 404. The user 405 can view the map 420 and can modify the map 422, such as using one or more interfaces (e.g., a touch screen) of the mobile device 404. The map can be updated 424 by the user 405 or the mobile device 404 and can be transmitted 426 to the cloud computing system 406 or the robot 100, allowing the robot 100 to use the updated map when executing one or more missions or behaviors 428. Optionally, the map 414 can be unmodified by a user and can be used 427 by the robot 100 to execute one or more missions or behaviors 428.

Operations of the process 401 and other processes described herein, such one or more steps discussed below, can be executed in a distributed manner. For example, the cloud computing system 406, the mobile robot 100, and the mobile device 404 can execute one or more of the operations in concert with one another. Operations described as executed by one of the cloud computing system 406, the mobile robot 100, and the mobile device 404 are, in some implementations, executed at least in part by two or all of the cloud computing system 406, the mobile robot 100, and the mobile device 404.

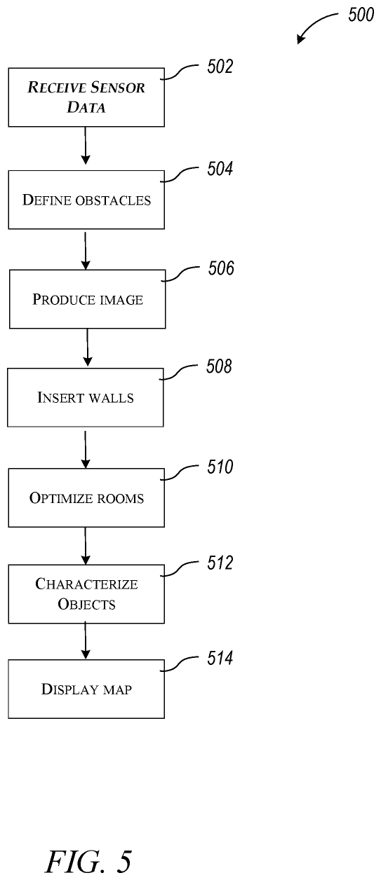

FIG. 5 illustrates a schematic view of the method 500, in accordance with at least one example of this disclosure. The method 500 can be a method of modifying a boundary of a map of an environment (or of creating a map of an environment). The steps or operations of the method 500 are illustrated in a particular order for convenience and clarity; many of the discussed operations can be performed in a different sequence or in parallel without materially impacting other operations. The steps or operations of the method 500 can be omitted or can be performed multiple times. The method 500 as discussed includes operations that can be performed by multiple different actors, devices, and/or systems. It should be understood that subsets of the operations discussed in the method 500 can be attributable to a single actor, device, or system could be considered a separate standalone process or method.

The method 500 can be performed by one or more of the robot 100, the cloud computing system 406, or the mobile device 404, and can include or can be part of one or more of the steps of the process 401 discussed above, such as the steps 413 or the 414. The method 500 can begin at step 502, where sensor data can be received, such as by the robot 100, the mobile device 404, or the cloud computing system 406. The sensor data can include data from one or more of the sensors of the robot 100 based on interactions between the mobile cleaning robot 100 and the environment 40.

At step 504, obstacles can be defined, such as by generating a boundary of traversable space by the mobile cleaning robot within the environment using the sensor data, such as using optical or bump sensor data. The boundary can at least partially define non-traversable space of the environment, optionally at a height of the robot 100 from the floor of the environment. The non-traversable space can include space beyond a boundary that has been observed by the mobile cleaning robot and has not been traversed by the mobile cleaning robot. At step 506, an image or map can be produced, where the image can represent one or more obstacles or boundaries of or within the environment. The image can be further modified to generate a modified boundary of the environment using the non-traversable space and the sensor data, such as by inserting or moving walls 508 or otherwise partitioning or subdividing space within the modified boundary. A map of the environment can be generated based at least in part on the boundary or the modified boundary.

At step 510, rooms can be optimized. For example, the map or space can be segmented or partitioned into rooms defined by room boundaries based at least in part on the modified boundary or based at least in part on the non-traversable space. Regions obtained from partitioned negative spaces can be assigned to rooms based on associated visual features observed from the space inside the room. At step 512, objects within, or within portions of, the space, such as non-traversable space, can be characterized. For example, based on the sensor data and the map, spaces or objects can be characterized as walls or other immobile objects. Optionally, room boundaries can be modified based at least in part on the characterized portion(s) of the non-traversable space.

Such a method can be computationally efficient because it does not require an expensive or complex model to recognize or define the negative spaces as objects. Therefore, the robot 100 can be used to build or assemble a more accurate map with relatively inexpensive sensors and processors.

In some examples, the objects or space can be characterized in three dimensions. For example, a height of the characterized portion can be determined using data or images from the robot 100, such as data or images indicative or corners or lines of an objected. Then, a three-dimensional representation of each of the characterized portions can be generated (e.g., by the mobile device 404 or the cloud computing system 406) such as by using the map and the height of the characterized portions. A three-dimensional map can be generated based at least on the map and based on the three-dimensional representations of the characterized portion. At step 514, a map can be displayed, which can include any of the versions of the maps discussed above.

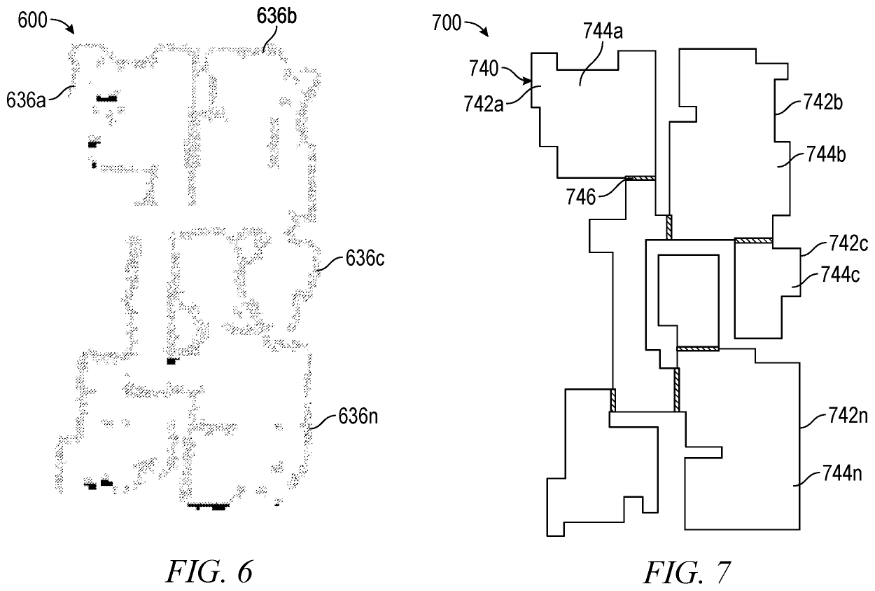

FIG. 6 illustrates a plan view of a map 600 of an environment, such as the environment 40. The map 600 can be a preliminary map or a visualization of a collection of data points gathered by the robot 100. For example, each object 636 (of the objects 636a-636n) can be a portion of the environment that is non-traversable by the robot 100 and can define, at least in part, a preliminary boundary of the space or environment. Whether each portion is non-traversable can be determined by comparing each object or portion recorded or stored by the robot 100, the cloud computing system 406, or the mobile device 404, to each portion traversed at some point during one or more mission by the robot 100. In other words, each object or portion 636 can be a portion of the environment 40 not traversed by the robot 100 but captured through one or more events or interactions by the robot 100, such as a bump indicated by a bump sensor or an image captured by an image capture device or LiDAR (light detection and ranging). Optionally, each portion 636 can be an interaction (or lack of an interaction).

FIG. 7 illustrates a plan view of a map 700 of an environment. The map 700 can be a modified map or visualization of a map generated based on data points shown in the map 600. The robot 100, the mobile device 404, or the cloud computing system 406 (or another device) can generate a boundary of traversable space by the mobile cleaning robot within the environment 40 using the sensor data, where the boundary at least partially defines non-traversable space of the environment, and the non-traversable space includes a region beyond the boundary. FIG. 7 shows how the device (or system) can segment the map 700 into rooms defined by room boundaries based at least in part on a modified boundary or non-traversable space.

More specifically, the robot 100, the mobile device 404, or the cloud computing system 406 can use one or more of the objects or portions 636 (of the map 600) of the environment 40 to generate a boundary 740 of the environment 40. The boundary 740 can include one or more room borders 742, such as the room border 742a-742n. The room borders 742 can independently or collectively define one or more rooms 744, such as the rooms 744a-744n, and can be an example of a modified boundary of the environment or space. For example, the room border 742a can, at least in part, define the room 744a and the room border 742b can define the room 744b.

The room borders 742 can be placed within the map 700 based on the objects or portions 636 of the map 600 that are non-traversable, such that the room borders 742 can generally be relatively straight lines deduced or determined from the non-traversable portions 636. The one or more rooms 744 can be determined or placed based on the room borders 742 and openings 746. The openings 746 can be deduced (such as based on the portions 636 or lack thereof) to be doorways or passageways between rooms. Such a map can be presented to the user 405, such as via the mobile device 404, or can be further modified, as described below.

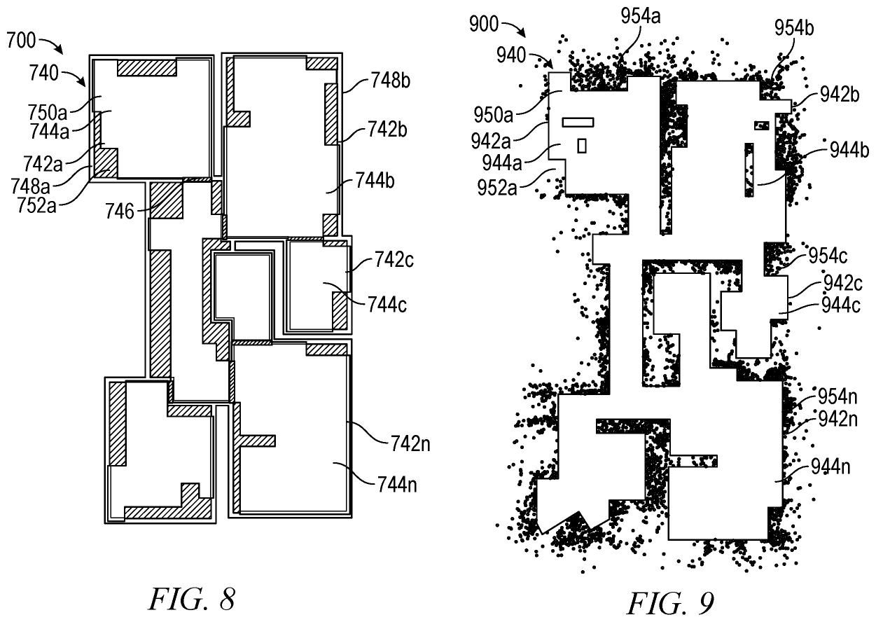

FIG. 8 illustrates a plan view of the map 700 of an environment. The map 700 can be consistent with the map 700 discussed with respect to FIG. 7; FIG. 8 shows how the map 700 can be preliminarily modified. More specifically, FIG. 8 shows that the border 740 can be modified by moving the border 740 to a periphery of the space and forming an approximation of outer walls of the environment or outer walls of the room. The boundary 740 can be an example of a modified boundary or border of the space or environment.

FIG. 8 also shows that the map 700 can be segmented into rooms 744 defined by the room boundaries 742. Placement of the boundaries 742 can be determined based at least in part on the modified boundary 748 or based at least in part on the non-traversable space as determined by or from interactions between the robot 100 and the environment (e.g., the portions 636). An outer wall 748a can be placed around traversable space 750a of the room 744a and around non-traversable space 752a to re-form a shape of the room 744a, such as based on the non-traversable space. The rooms 744b-744n can be similarly modified to redefine the boundary 740 of the map 700, helping to create a more accurate, more recognizable, or more realistic version of the map 700 for presentation to the user.

The boundary 748 can be determined by placing one or more polygons to represent a space that aligns or substantially aligns with the portions 636. Once polygons are placed, one or more system or device can determine whether the polygon defines a valid region or room with respect to other regions or rooms of the map or environment, such as by using one or more constraints or rules, such as rectilinear analysis, nearly convex segmentation, shape grammar analysis, room aspect ratio analysis, hallway aspect ratio analysis, or grouping of adjacent rooms. Optionally, an evaluator can be used to assess the validity of the polygon defining the region or room, where the evaluator can provide a score to define how close a polygon defines a room.

Optionally, one or more system or device can determine whether the polygon defines an invalid region or room, such as by using one or more constraints or rules such as room segmentation, based on a medial axis of the free space, using nearly convex segmentation, visible space segmentation (segmenting the visible space of the environment), informed segmentation (e.g., based on floor types, room types, thresholds, or the like), or based on random segmentation of the rooms or environment. Once the polygon satisfies the rules or analysis as a valid region and is determined not to be an invalid region, it can be placed as a modified border (e.g., the modified boundary 748a).

Once a single valid polygon or modified boundary 748 is placed, the valid modified boundary can be used to place additional modified boundaries. A set of operations that can create a valid modified boundary or polygon from another valid modified boundary or polygon can be used, such as by shifting edges of boundaries adjacent the valid boundary, or by moving one or more vertex of the boundaries adjacent the valid boundary. For example, once the boundary 748a is determined to be valid, edges of the boundary 748b can be modified or moved (such as in normal or parallel directions), or vertices of the boundary 748b can be modified or moved, such as to better align with the boundary 748a.

Once a boundary 748 and the room borders 742 are placed, they can be analyzed for fitness within the space or environment. For example, the boundary 748 can be determined to define a room or region and the room or region can be compared to other data or analyses to determine how well the boundary 748 and a border 742 represent a room or space. For example, the boundary 748a or the room 744a can be compared to the map 600 (or the data thereof) to determine fit of the boundary 748a or the room 744a.

Following fitness analysis (or following any other step), the boundaries 748 can be improved to increase fitness between the produced floor plan and the raw occupancy map 600 in FIG. 6, optionally using one or more of the processes discussed above or discussed below with respect to FIGS. 9-16. Optionally, the boundaries 748 can be improved in other ways. For example, the boundary 748 can be optimized using dynamic analysis, such as good-and-old analysis. The boundary 748 can also be optimized using gradient based analysis, a stochastic optimizer, population-based metaheuristics, a Monte Carlo tree search, a hidden Markov model, a general adversarial network. Following optimization (or any other step discussed above), the boundary 748 can be finalized and the map 700 can be presented to the user 405, such as via the mobile device 404, or can be further modified, as described below.

FIG. 9 illustrates a plan view of the map 700 of an environment. The map 900 can be similar to the maps 600-700 discussed above with respect to FIGS. 6-8. FIG. 9 shows a different environment or the same environment derived from different data, and shows how a map can be further modified following preliminary modification of its border.

The map 900 can include a border 940 at least partially defined by boundaries 942a-942n, which can separate traversable space 950 from non-traversable space 952. The boundaries 942a-942n can be used to at least partially define rooms 940a-940n. The map 900 can be updated to include data or images representing visual features or objects (such as points or lines) captured within the environment, but outside of the traversable space 950. For example, an object 954a can be located outside of the traversable space 950a (beyond the room border 942a) of the room 954b but in the non-traversable space 952a adjacent the room 944a. The features 948a-948n can be similarly overlayed onto the map (or otherwise used) to further modify the map 900 and the boundary 940.

The features 954 can be produced or generated from one or more data point or analysis from one or more data point, such as based on sensor data from the robot 100. For example, the features 954 can be derived from one or more of SLAM data, VSLAM data, ODOA data, VSU data, LiDAR or the like. As discussed in further details below, the features 954 can be used to further modify the map 900.

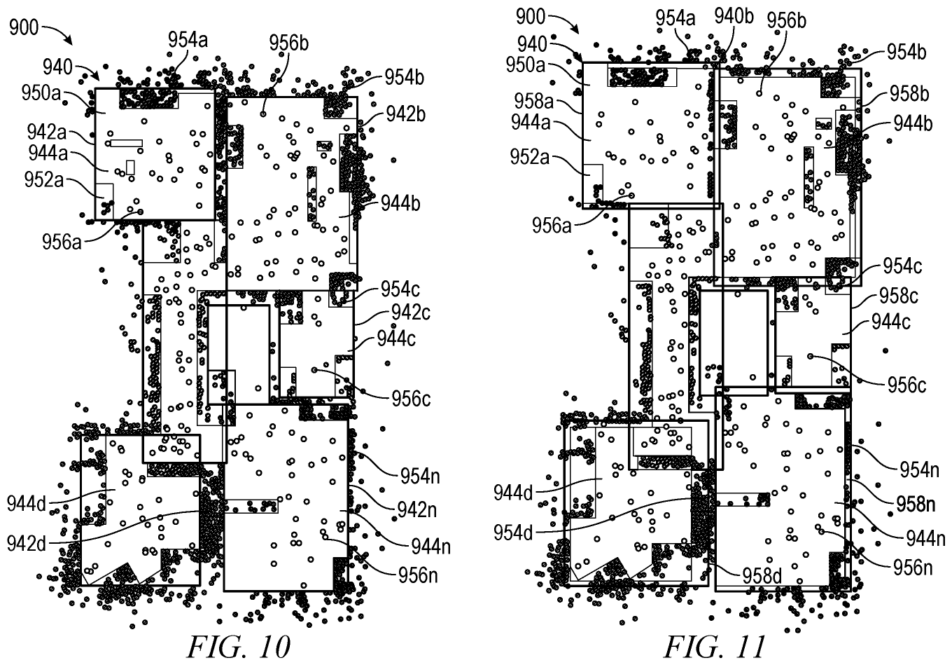

FIG. 10 illustrates a plan view of the map 900 of an environment. The map 900 can be derived from or can include the map 900 of FIG. 9. FIG. 10 shows additional data and modifications to the map 900. For example, FIG. 10 shows that the border 940 can be overlayed on the map 900, where the border 940 can be derived from the steps discussed above with respect to FIGS. 6-7 or can be derived based on the boundaries 940.

The map 900 can also include the features 954a-954 located in the non-traversable space 952 (or outside of the traversable space 950) of the environment. FIG. 10 also shows positions or poses 956a-956n of the robot 100. Each pose 956 shown on the map 900 can be representative of a location on the map 900 of where the robot 100 is or was located when the features 954 outside of the traversable space 950 were collected. For example, the pose 956a can represent a location of the robot within the environment when the feature 954a was recorded.

The poses 956 and the features 954 can be grouped based on the room of the map 900, such as based on in which room the pose 956 was recorded and to which rooms the features 954 were near (or relatively near). For example, all of the features 954 (e.g., 954a) associated with poses 956 (e.g., 956a) that occurred within the room 944a can be grouped together and all of the features all of the features 954 (e.g., 954b) associated with poses 956 (e.g., 956b) that occurred within the room 944b can be grouped together. Such features can be represented on the 900 in different or discreet colors. The border 940 of each room can be adjusted or modified based on the groupings or one or more of the poses 956 or features 954. For example, the border 940 can be adjusted from the border 940 developed or produced in the steps or procedures of FIGS. 6-8 (e.g., the 740). The border 940 can also be further modified, as discussed with respect to FIG. 11.

FIG. 11 illustrates a plan view of the map 900 of an environment. The map 900 can be consistent with the map 900 of FIGS. 10-11. FIG. 11 shows how the map can be further modified. For example, FIG. 11 shows how the border 940 can be modified based on features and positions.

The room borders 958 can be an example of a modified boundary or border of the space or environment. More specifically, FIG. 11 shows that each room border 958 can be modified based on the features 954 and the poses 956. For example, a room border 958a can be modified from the room border 942a based at least in part on the objects 954a and poses 956a associated with the room 944a and the room border 958b can be modified from the room border 942b based at least in part on the objects 954b and poses 956b associated with the room 944b. The other room border 958 can be similarly modified based on their associated features 954 and poses 956.

As shown in FIG. 11, the room border 958d and the room border 958n can be increased, respectively, from the room border 942d and the room border 942n, such as to include walls of the respective rooms in the respective rooms. For example, the gap between the borders 942d and 942n can be assigned to the room 944d and the border 954d can be moved accordingly.

Optionally, a height of each of the features 954 can be considered (e.g., by the robot 100, the mobile device 404, or the cloud computing system 406) to determine which objects 954 are walls and can therefore be used to determined where to place each of the room borders 958. Also, the room borders 958, when modified, may overlap, such as the room border 958a and the room border 958b. Such an overlap can indicate that a wall dividing the rooms 944a and the room 944b is located at or between the shared and overlapping room borders.

As also shown in FIG. 11, the room borders 958 can be modified or moved to include more of the objects 954 from the non-traversable space 952 within the rooms. For example, a height of the objects or features 954 can be considered (e.g., by the robot 100, the mobile device 404, or the cloud computing system 406) to determine which objects 954 are not walls (or windows), such as furniture (e.g., beds or bookshelves) and should be incorporated into the rooms 942. For example, FIG. 11 shows that a room border 958d of a room 944d can be expanded to include features or objects 954d, which can have a height smaller than that of perceived walls or ceilings, indicating that the objects 954d represent an object within the room 944d, such as a furniture item. The borders 958 can further be analyzed (such as for fit or optimization) using one or more of the steps or processes discussed above with respect to FIGS. 6-8.

As discussed in further detail below, each of the objects 954 (or groups of objects or features or negative space) can be grouped or classified by the robot 100, the mobile device 404, or the cloud computing system 406. For examples, objects or regions of inaccessible space can be characterized as walls, (long internal, external), windows, inaccessible rooms, built-ins (short, large, stationary items, such as large furniture, cabinets, appliances), or clutter (small spaces, limited changes, such as toy bins, kitchen chairs). Also, objects can be classified as stationary objects or dynamic or obstacles (objects moving in space), or clutter. Such classifications can be further used to modify the room borders 958 or the map 900 in other ways.

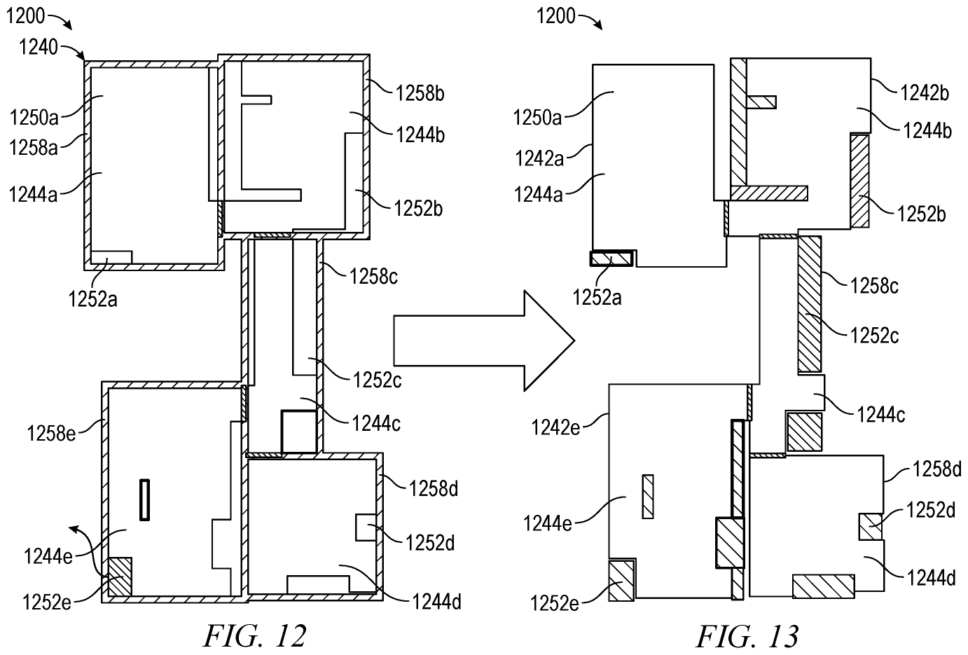

FIG. 12 illustrates a plan view of a map 1200 of an environment. FIG. 13 illustrates a plan view of the map 1200 of an environment. FIGS. 12 and 13 are discussed together below.

The map 1200 can be similar to the maps discussed above. The map 1200 illustrates a different environment. FIG. 12 shows the map 1200 where a border 1240 includes a modified border 1258 (e.g., 1258a-1258d) associated with each room 1244a-1244d. FIG. 12 also shows traversable space 1250 associated with each room (e.g., 1250a-1250d) and negative space (or non-traversable space) 1252, which can include non-traversable space associated with each room (e.g., 1252a-1252d). The map 1200 can be representative of a map where the border has been adjusted based on height of the objects or features therein or adjusted in other ways, as discussed above. For example, the modified borders 1258 can be derived based at least in part on data from the robot 100, such as including height determined from objects (e.g., the features 954) within the map 900 or environment.

FIG. 12 shows the non-traversable space 1252 located within each room and FIG. 13 shows the map 1200 with the border 1240 (e.g., the modified borders 1258) removed and shows the non-traversable space 1252a-1252d as discreet or individual objects. FIG. 13 also shows an example of how the objects can be categorized. For example, a device or system, such as the robot 100, the mobile device 404, or the cloud computing system 406 can use data from the robot 100, such as one or more objects or features (e.g., the features 954) to determine characteristics about each section of the non-traversable space 1252.

For example, the features (e.g., the features 954) can be used to determine a height, width, or depth of each object (in some examples before an identity of the object can be determined), including whether the object is flush with the floor or ceiling or includes a gap therebetween. These determinations can be made by a device or system and can be used to characterize each portion of the non-traversable space 1252. For example, the non-traversable space 1252a can be determined to be an object, such as by determining the non-traversable space 1252a has a height lower than a height of the walls or ceiling. Similarly, the non-traversable spaces 1252d and 1252e can determined to be objects. The non-traversable space 1252b can determined to be a wall, such as by determining the non-traversable space 1252b has a height common with other walls or the ceiling. The non-traversable space 1252c can be determined to be an inaccessible space, such as based on a determination that the robot 100 cannot access the space or the dimensions are indeterminable. As the robot 100 gathers more observations from subsequent missions, more regions of negative or non-traversable space can be better recognized and classified. Once each portion of non-traversable space 1252 is characterized, the border 1240 can be updated (such as described below), and the non-traversable spaces 1252 can be further modified to produce a more accurate representation of the map 1200, as discussed below.

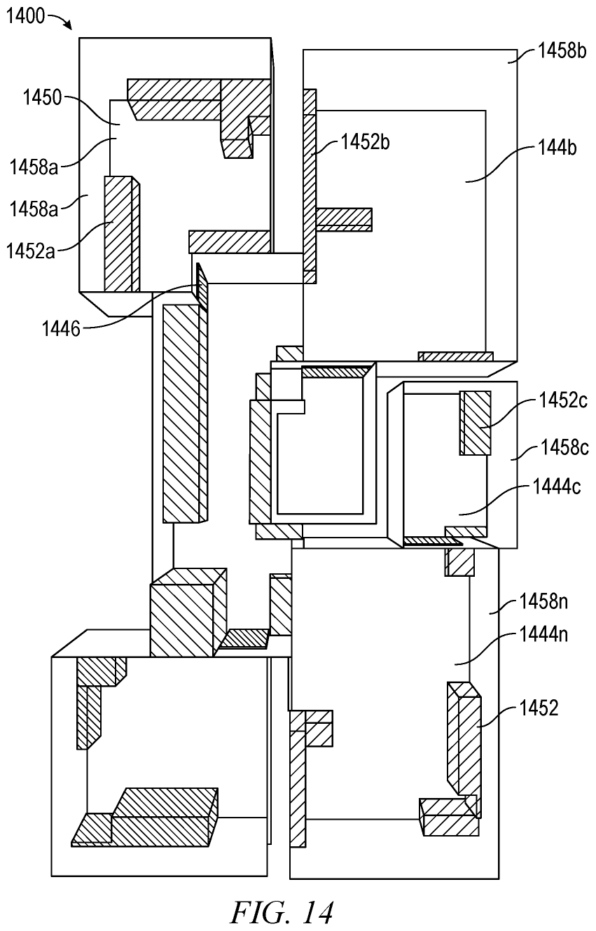

FIG. 14 illustrates a perspective view of a map 1400 of an environment. The map 1400 can be similar to the maps discussed above. The map 1400 illustrates a different environment. The map 1400 can be representative of a map where the non-traversable spaces have been characterized or categorized, as discussed above. FIG. 14 shows the map 1400 where the non-traversable objects and walls 1452 are represented in three dimensions.

More specifically, the map 1400 can include rooms 1444 (e.g., rooms 1444a-1444n) including modified borders 1458 (e.g., borders 1458a-1458n), which can include non-traversable space 1452 (e.g., non-traversable space or objects 1452a-1452n). The map 1400 can also include openings 1446, which can be doors or entryways between rooms. FIG. 14 shows the map 1400 where the non-traversable objects and walls 1452 are represented in three dimensions.

Once the items are characterized, such as based at least in part on dimensions of the objects (as discussed above with respect to FIGS. 6-13), the objects or non-traversable space 1452 can be represented based on the deductions or characterizations. For example, the walls 1458 (such as the walls 1458a) can be all of the same or similar height and can be shown in a common color. Other non-traversable space 1452 or objects can be shown to have their determined heights or heights relative to the walls 1458. For example, the non-traversable space or object 1452c can have a height that is lower or smaller than a height of the walls, to indicate the presence of a bed or table.

Optionally, the non-traversable space 1452 or objects or objects of each room can be shown in a common color, by room, to help distinguish between spaces or rooms of the environment. The openings 1446 can also be represented as having a reduced height relative to the walls or borders 1458. In this way, a three-dimensional representation of the environment can be presented as the map 1400, which can help a user more easily recognize the mapped space and can help the user more easily modify and customize the map for robot operations and missions.

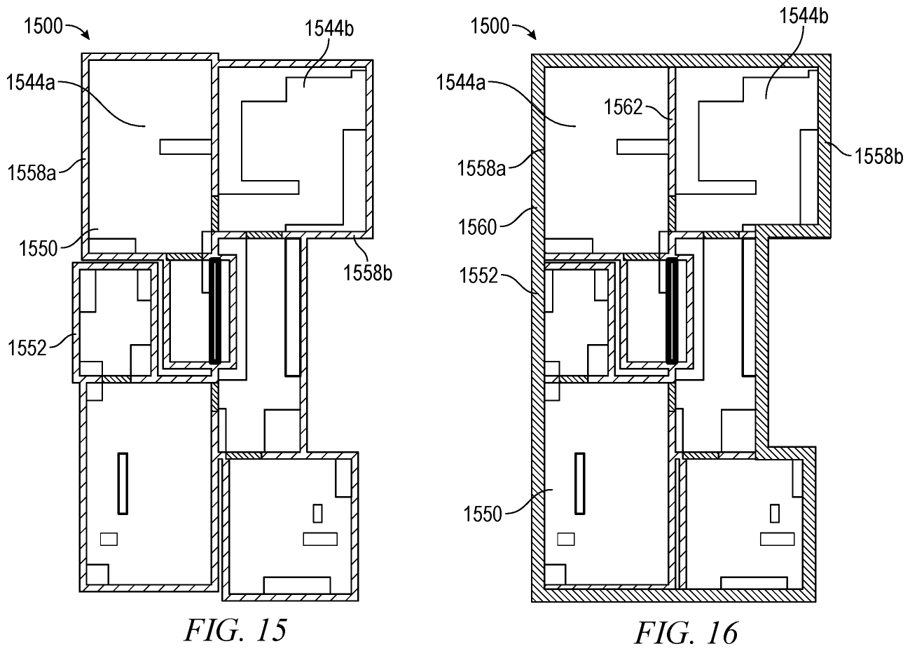

FIG. 15 illustrates a plan view of a map 1500 of an environment. FIG. 16 illustrates a plan view of the map 1500 of an environment. FIGS. 15 and 16 are discussed together below. The map 1500 can be similar to any of the maps discussed above such that the map 1500 can include rooms 1444 (e.g., room 1444a). FIGS. 15 and 16 show how a map can be optionally modified.

For example, FIG. 15 shows the map 1500 including borders 1558, which can be determined based on any of the methods or steps discussed above. FIG. 16 shows how the borders 1558 can be modified such that external walls 1560 are represented by a relatively thicker line or border and internal walls 1562 are represented by a relatively thinner line or border that can appear as a higher quality floor plan or map, which, when presented to a user, can help the user more easily recognize the environment.

To determine which walls are internal and external walls, the robot 100, the mobile device 404, or the cloud computing system 406 can use data from the robot 100, such as sensor data, to determine which walls are common walls and which walls are not shared or common. One or more of the devices or systems can also determine which walls are located at or near a perimeter of traversable space 1550, or which walls are located near or beyond a perimeter of the traversable space, or which walls are located in or near non-traversable space.

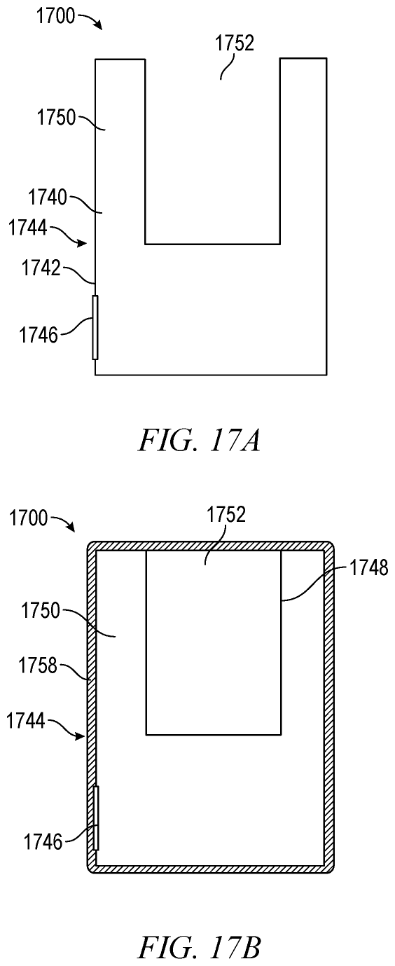

FIG. 17A illustrates a plan view of a map 1700 of an environment. FIG. 17B illustrates a plan view of the map 1700 of an environment. The map 1700 can be similar to any of the maps discussed above such that the map 1700 can include a room 1744. FIGS. 17A and 17B show how a map can be optionally modified.

More specifically, the robot 100, the mobile device 404, or the cloud computing system 406 can use one or more of the objects or portions 636 (of the map 600) of the environment 40 to generate a boundary 1740 of the environment 40, as shown in FIG. 17A. The boundary 1740 can be or can include a room borders 1742. The boundary 1740 can be at least partially defined by non-traversable space 1752 and can include traversable space 1750. In FIG. 17A, the non-traversable space 1752, prior to modification thereof, can cause the boundary 1740 to appear as a relatively unrecognizable shape, e.g., a U-shape, due to a relatively large portion of the room 1744 being taken up by the non-traversable space 1752, which can be a bed, desk, or other relatively large object. One or more of the methods or steps discussed above can be used to modify the map 1700.

FIG. 17B shows how the boundary 1740 can be modified to generate the modified boundary 1758 and to represent the non-traversable space 1752 with a polygon to define a modified boundary 1748 of the non-traversable space 1752. For example, FIG. 17B shows how the modified boundary 1758 can better represent a room with a bed, which may be more recognizable to a user than the U-shaped space of FIG. 17A.

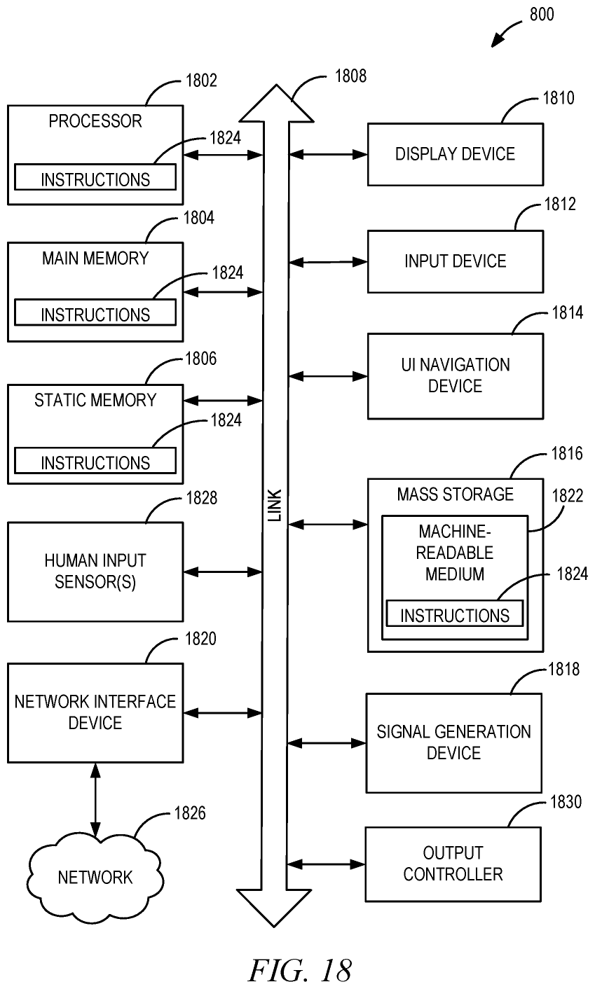

FIG. 18 illustrates a block diagram of an example machine 1800 upon which any one or more of the techniques (e.g., methodologies) discussed herein may perform. Examples, as described herein, may include, or may operate by, logic or a number of components, or mechanisms in the machine 1800. Circuitry (e.g., processing circuitry) is a collection of circuits implemented in tangible entities of the machine 1800 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 1800 follow.

In alternative embodiments, the machine 1800 may operate as a standalone device or may be connected (e.g., networked) to other machines. In a networked deployment, the machine 1800 may operate in the capacity of a server machine, a client machine, or both in server-client network environments. In an example, the machine 1800 may act as a peer machine in peer-to-peer (P2P) (or other distributed) network environment. The machine 1800 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 1800 may include a hardware processor 1802 (e.g., a central processing unit (CPU), a graphics processing unit (GPU), a hardware processor core, or any combination thereof), a main memory 1804, a static memory (e.g., memory or storage for firmware, microcode, a basic-input-output (BIOS), unified extensible firmware interface (UEFI), etc.) 1806, and mass storage 1808 (e.g., hard drive, tape drive, flash storage, or other block devices) some or all of which may communicate with each other via an interlink (e.g., bus) 1830. The machine 1800 may further include a display unit 1810, an alphanumeric input device 1812 (e.g., a keyboard), and a user interface (UI) navigation device 1814 (e.g., a mouse). In an example, the display unit 1810, input device 1812 and UI navigation device 1814 may be a touch screen display. The machine 1800 may additionally include a storage device (e.g., drive unit) 1808, a signal generation device 1818 (e.g., a speaker), a network interface device 1820, and one or more sensors 1816, such as a global positioning system (GPS) sensor, compass, accelerometer, or other sensor. The machine 1800 may include an output controller 1828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 1802, the main memory 1804, the static memory 1806, or the mass storage 1808 may be, or include, a machine readable medium 1822 on which is stored one or more sets of data structures or instructions 1824 (e.g., software) embodying or utilized by any one or more of the techniques or functions described herein. The instructions 1824 may also reside, completely or at least partially, within any of registers of the processor 1802, the main memory 1804, the static memory 1806, or the mass storage 1808 during execution thereof by the machine 1800. In an example, one or any combination of the hardware processor 1802, the main memory 1804, the static memory 1806, or the mass storage 1808 may constitute the machine readable media 1822. While the machine readable medium 1822 is illustrated as a single medium, the term “machine readable medium” may include a single medium or multiple media (e.g., a centralized or distributed database, and/or associated caches and servers) configured to store the one or more instructions 1824.

The term “machine readable medium” may include any medium that is capable of storing, encoding, or carrying instructions for execution by the machine 1800 and that cause the machine 1800 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1824 may be further transmitted or received over a communications network 1826 using a transmission medium via the network interface device 1820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1820 may include one or more physical jacks (e.g., Ethernet, coaxial, or phone jacks) or one or more antennas to connect to the communications network 1826. In an example, the network interface device 1820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1800, and includes digital or analog communications signals or other intangible medium to facilitate communication of such software. A transmission medium is a machine readable medium.

### Notes and Examples

The following, non-limiting examples, detail certain aspects of the present subject matter to solve the challenges and provide the benefits discussed herein, among others.

Example 1 is at least one non-transitory machine-readable medium, including instructions, which when executed, cause processing circuitry to perform operations to: receive sensor data from a mobile cleaning robot based on interactions between the mobile cleaning robot and an environment; generate a boundary of traversable space by the mobile cleaning robot within the environment using the sensor data, the boundary at least partially defining non-traversable space of the environment, and the non-traversable space including a region beyond the boundary; and generate a modified boundary of the environment using the non-traversable space and the sensor data.

In Example 2, the subject matter of Example 1 optionally includes the instructions to further cause the processing circuitry to perform operations to: generate a map of the environment based on the modified boundary.

In Example 3, the subject matter of Example 2 optionally includes the instructions to further cause the processing circuitry to perform operations to: segment the map into rooms defined by room boundaries based at least in part on the modified boundary.

In Example 4, the subject matter of Example 3 optionally includes wherein the map is segmented into rooms based at least in part on the non-traversable space.

In Example 5, the subject matter of Example 4 optionally includes the instructions to further cause the processing circuitry to perform operations to: characterize portions of the non-traversable space using the sensor data.

In Example 6, the subject matter of Example 5 optionally includes the instructions to further cause the processing circuitry to perform operations to: modify the room boundaries based at least in part on the characterized portions of the non-traversable space.

In Example 7, the subject matter of Example 6 optionally includes wherein the portions are characterized using images captured by an image capture device of the mobile cleaning robot.

In Example 8, the subject matter of Example 7 optionally includes wherein the images are captured using a VSLAM process.

In Example 9, the subject matter of any one or more of Examples 7-8 optionally include the instructions to further cause the processing circuitry to perform operations to: determine a height of the characterized portions using the images; and generate a three dimensional representation for each of the characterized portions using the map and the height of the characterized portions.

In Example 10, the subject matter of Example 9 optionally includes the instructions to further cause the processing circuitry to perform operations to: generate a three dimensional map based on the map and based on the three dimensional representations of the characterized portions.

In Example 11, the subject matter of any one or more of Examples 1-10 optionally include wherein the non-traversable space includes space beyond the boundary that has been observed by the mobile cleaning robot and has not been traversed by the mobile cleaning robot.

Example 12 is a method of generating a map of an environment using a mobile cleaning robot, the method comprising: receiving sensor data based on interactions between the mobile cleaning robot and the environment; generating a boundary of traversable space by the mobile cleaning robot within the environment using the sensor data, the boundary at least partially defining non-traversable space of the environment; generating a modified boundary of the environment using the non-traversable space and the sensor data; and generating a map of the environment based on the modified boundary.

In Example 13, the subject matter of Example 12 optionally includes wherein the non-traversable space includes space beyond the boundary that has been observed by the mobile cleaning robot and has not been traversed by the mobile cleaning robot.

In Example 14, the subject matter of any one or more of Examples 12-13 optionally include segmenting the map into rooms defined by room boundaries based at least in part on the modified boundary.

In Example 15, the subject matter of Example 14 optionally includes wherein the map is segmented into rooms based at least in part on the non-traversable space.

In Example 16, the subject matter of Example 15 optionally includes characterizing a portion of the non-traversable space using the sensor data.

In Example 17, the subject matter of Example 16 optionally includes modifying the room boundaries based at least in part on the characterized portion of the non-traversable space.

In Example 18, the subject matter of Example 17 optionally includes determining a height of the characterized portion using the images; and generating a three dimensional representation for each of the characterized portions using the map and the height of the characterized portions; and generating a three dimensional map based on the map and based on the three dimensional representations of the characterized portion.

Example 19 is at least one non-transitory machine-readable medium, including instructions, which when executed, cause processing circuitry to perform operations to: receive sensor data from a mobile cleaning robot based on interactions between the mobile cleaning robot and an environment; generate a boundary of traversable space by the mobile cleaning robot within the environment using the sensor data, the boundary at least partially defining non-traversable space of the environment, and the non-traversable space including a region beyond the boundary; and generate a modified boundary of the environment using the non-traversable space and the sensor data.

In Example 20, the subject matter of Example 19 optionally includes the instructions to further cause the processing circuitry to perform operations to: generate a map of the environment based on the modified boundary.

In Example 21, the subject matter of Example 20 optionally includes the instructions to further cause the processing circuitry to perform operations to: segment the map into rooms defined by room boundaries based at least in part on the modified boundary.

In Example 22, the subject matter of Example 21 optionally includes wherein the non-traversable space includes space beyond the boundary that has been observed by the mobile cleaning robot and has not been traversed by the mobile cleaning robot.

Example 23 is an apparatus comprising means to implement of any of Examples 1-20.

Example 24 is a system to implement of any of Examples 1-20.

Example 25 is a method to implement of any of Examples 1-20.

In Example 26, the system, apparatus(es), or method of any one or any combination of Examples 1-25 can optionally be configured such that all elements or options recited are available to use or select from.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. At least one non-transitory machine-readable medium, including instructions, which when executed, cause processing circuitry to perform operations to:
receive sensor data from a mobile cleaning robot based on interactions between the mobile cleaning robot and an environment;
generate a boundary of traversable space by the mobile cleaning robot within the environment using the sensor data, the boundary at least partially defining non-traversable space of the environment, and the non-traversable space including a region beyond the boundary; and
generate a modified boundary of the environment using the non-traversable space and the sensor data.

2. The at least one non-transitory machine-readable medium of claim 1, the instructions to further cause the processing circuitry to perform operations to:
generate a map of the environment based on the modified boundary.

3. The at least one non-transitory machine-readable medium of claim 2, the instructions to further cause the processing circuitry to perform operations to:
segment the map into rooms defined by room boundaries based at least in part on the modified boundary.

4. The at least one non-transitory machine-readable medium of claim 3, wherein the map is segmented into rooms based at least in part on the non-traversable space.

5. The at least one non-transitory machine-readable medium of claim 4, the instructions to further cause the processing circuitry to perform operations to:
characterize portions of the non-traversable space using the sensor data.

6. The at least one non-transitory machine-readable medium of claim 5, the instructions to further cause the processing circuitry to perform operations to:
modify the room boundaries based at least in part on the characterized portions of the non-traversable space.

7. The at least one non-transitory machine-readable medium of claim 6, wherein the portions are characterized using images captured by an image capture device of the mobile cleaning robot.

8. The at least one non-transitory machine-readable medium of claim 7, wherein the images are captured using a VSLAM process.

9. The at least one non-transitory machine-readable medium of claim 7, the instructions to further cause the processing circuitry to perform operations to:
determine a height of the characterized portions using the images; and
generate a three dimensional representation for each of the characterized portions using the map and the height of the characterized portions.

10. The at least one non-transitory machine-readable medium of claim 9, the instructions to further cause the processing circuitry to perform operations to:
generate a three dimensional map based on the map and based on the three dimensional representations of the characterized portions.

11. The at least one non-transitory machine-readable medium of claim 1, wherein the non-traversable space includes space beyond the boundary that has been observed by the mobile cleaning robot and has not been traversed by the mobile cleaning robot.

12. A method of generating a map of an environment using a mobile cleaning robot, the method comprising:
receiving sensor data based on interactions between the mobile cleaning robot and the environment;
generating a boundary of traversable space by the mobile cleaning robot within the environment using the sensor data, the boundary at least partially defining non-traversable space of the environment;
generating a modified boundary of the environment using the non-traversable space and the sensor data; and
generating a map of the environment based on the modified boundary.

13. The method of claim 12, wherein the non-traversable space includes space beyond the boundary that has been observed by the mobile cleaning robot and has not been traversed by the mobile cleaning robot.

14. The method of claim 12, comprising:
segmenting the map into rooms defined by room boundaries based at least in part on the modified boundary.

15. The method of claim 14, wherein the map is segmented into rooms based at least in part on the non-traversable space.

16. The method of claim 15, comprising:
characterizing a portion of the non-traversable space using the sensor data.

17. The method of claim 16, comprising:
modifying the room boundaries based at least in part on the characterized portion of the non-traversable space.

18. The method of claim 17, comprising:
determining a height of the characterized portion using the images;
generating a three dimensional representation for each of the characterized portions using the map and the height of the characterized portions; and
generating a three dimensional map based on the map and based on the three dimensional representations of the characterized portion.

19. At least one non-transitory machine-readable medium, including instructions, which when executed, cause processing circuitry to perform operations to:
receive sensor data from a mobile cleaning robot based on interactions between the mobile cleaning robot and an environment;
generate a boundary of traversable space by the mobile cleaning robot within the environment using the sensor data, the boundary at least partially defining non-traversable space of the environment, and the non-traversable space including a region beyond the boundary; and
generate a modified boundary of the environment using the non-traversable space and the sensor data.

20. The at least one non-transitory machine-readable medium of claim 19, the instructions to further cause the processing circuitry to perform operations to:
generate a map of the environment based on the modified boundary.

21. The at least one non-transitory machine-readable medium of claim 20, the instructions to further cause the processing circuitry to perform operations to:
segment the map into rooms defined by room boundaries based at least in part on the modified boundary.

22. The at least one non-transitory machine-readable medium of claim 21, wherein the non-traversable space includes space beyond the boundary that has been observed by the mobile cleaning robot and has not been traversed by the mobile cleaning robot.
